(19) United States
(12) Patent Application Publication
(10) Pub. No.: US 2008/0262773 A1
(43) Pub. Date: Oct. 23, 2008

(54) Systems and methods for measuring temperature

(75) Inventor: Robert L. Howell, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Exatron Inc.

(21) Appl. No.: 12/008,147

(22) Filed: Jan. 8, 2008

Related U.S. Application Data
(60) Provisional application No. 60/925,328, filed on Apr. 18, 2007.

(51) Int. Cl. G01K 15/00

(52) U.S. Cl. 702/99

(57) ABSTRACT

Systems and methods for determining a temperature sensitivity of a MEMS device are disclosed. An exemplary method includes determining a temperature response of a MEMS device at an arbitrary temperature and calibrating the MEMS device based on the temperature response.

### CROSS-REFERENCE TO RELATED APPLICATIONS

This application claims priority to U.S. Provisional Patent Application No. 60/925,328, filed on Apr. 18, 2007, the entirety of which is hereby incorporated by reference.

### FIELD

Embodiments of this invention relate to systems and methods for measuring temperature and, in particular, systems and methods for measuring temperature using a micro electro mechanical system (MEMs) device.

### BACKGROUND

Micro electro mechanical system (MEMS) devices, also referred to as Micromachines or Microsystem Technology (MST), are devices having mechanical elements that are manufactured at a very small scale (i.e., microelectronics).

MEMS devices come in a variety of sizes, shapes and colors. MEMS devices are used for a variety of purposes such as pressure sensors, temperature sensors, stable frequency sources and so on. MEMs devices of whatever kind are subject to performance variations due to the effect of temperature differences. Depending on the end use of the device, it is frequently necessary to calibrate the device for the effect of temperature variations.

One specific kind of MEMS device is a resonator, which is a mechanical device, similar to a tuning fork, which produces a stable audio frequency (vibration) when stimulated by a shock. The MEMS device is stimulated by an electrical signal and responds with a stable frequency. However, the frequency of the resonator varies as a function of temperature. If the MEMS device is used for a frequency source, a means of correcting for this temperature effect is required. Similarly, if the device is used as a temperature sensor, the temperature variation of the frequency must be calibrated with the required accuracy.

The current method of determining the temperature characteristics of MEMS devices is to put each individual device in a temperature chamber and vary the temperature slowly to obtain stable temperature measurement samples over a full range of required temperatures. This process, however, is very time-consuming and costly.

### BRIEF DESCRIPTION OF THE DRAWINGS

Embodiments of the invention are described by way of example with reference to the accompanying drawings, wherein:

FIG. 1 is a schematic view of a MEMs in accordance with one embodiment of the invention;

FIG. 2 is a schematic view of a packaged MEMs in accordance with one embodiment of the invention;

FIG. 3 is a schematic view of a MEMs resonator device in accordance with one embodiment of the invention;

FIG. 4 is a graph schematically illustrating a frequency input and temperature response of a MEMs as a function of time;

FIG. 5 is a block diagram of an exemplary process in accordance with one embodiment of the invention;

FIG. 6 is a block diagram of an exemplary MEMs system in accordance with one embodiment of the invention;

FIG. 7 is a block diagram of an exemplary test fixture in accordance with one embodiment of the invention;

FIG. 8 is a block diagram of an exemplary process in accordance with one embodiment of the invention; and

FIG. 9 is a block diagram of an exemplary computer system in accordance with one embodiment of the invention.

### DETAILED DESCRIPTION

Embodiments of the present invention relate to systems and methods for calibrating a micro electro mechanical system (MEMS) device at room temperature. Embodiments of the present invention also relate to systems and methods for measuring temperature using a MEMS device. Embodiments of the present invention also relate to systems and methods for testing, trimming, verifying and specifying a MEMS device in a single insertion into a test fixture. In one embodiment, calibration data is capture dynamically as the temperature changes during start up, when power is applied to a MEMS device.

Embodiments of the present invention include various operations, which will be described below. These operations may be performed by hardware components, software, firmware, or a combination thereof. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product which may include instructions stored on a machine-readable medium. These instructions may be used to program a general-purpose or special-purpose processor to perform the described operations. A machine-readable medium includes any mechanism for storing or transmitting information in a form (e.g., software, processing application) readable by a machine (e.g., a computer). The machine-readable medium may include, but is not limited to, magnetic storage media (e.g., floppy diskette); optical storage media (e.g., CD-ROM); magneto-optical storage media; read-only memory (ROM); random-access memory (RAM); erasable programmable memory (e.g., EPROM and EEPROM); flash memory; electrical, optical, acoustical, or other form of propagated signal (e.g., carrier waves, infrared signals, digital signals, etc.); or another type of media suitable for storing electronic instructions.

Additionally, some embodiments may be practiced in distributed computing environments where the machine-readable medium is stored on and/or executed by more than one computer system. In addition, the information transferred between computer systems may either be pulled or pushed across the communication medium connecting the computer systems such as in a remote diagnosis or monitoring system.

Unless stated otherwise as apparent from the following discussion, it will be appreciated that terms such as “processing,” “registering,” “determining,” “generating,” “correlating” or the like may refer to the actions and processes of a computer system, or similar electronic computing device, that manipulates and transforms data represented as physical (e.g., electronic) quantities within the computer system's registers and memories into other data similarly represented as physical within the computer system memories or registers or other such information storage, transmission or display devices. Embodiments of the method described herein may be implemented using computer software. If written in a programming language conforming to a recognized standard, sequences of instructions designed to implement the methods can be compiled for execution on a variety of hardware platforms and for interface to a variety of operating systems. In addition, embodiments of the present invention are not described with reference to any particular programming language. It will be appreciated that a variety of programming languages may be used to implement embodiments of the present invention.

Some portions of the description that follow are presented in terms of algorithms and symbolic representations of operations on data bits that may be stored within a memory and operated on by a processor. These algorithmic descriptions and representations are the means used by those skilled in the art to effectively convey their work. An algorithm is generally conceived to be a self-consistent sequence of acts leading to a desired result. The acts are those requiring manipulation of quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, parameters, or the like.

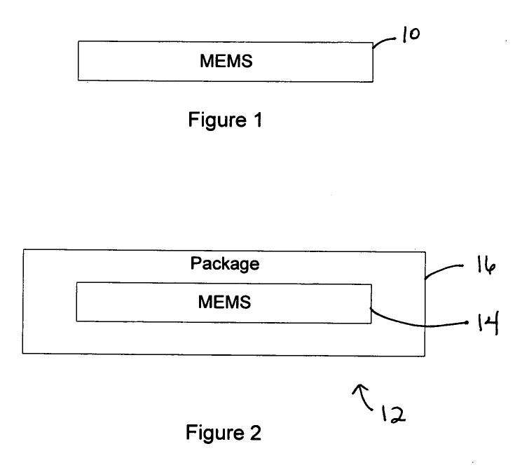

FIG. 1 illustrates a MEMS in accordance with one embodiment of the invention. The MEMS 10 may be, for example, a gyroscope, resonator, acceleromteter, sensor, etc.

The MEMS 10 is made using micromachining techniques to reduce mechanical components to a scale that is generally comparable to microelectronics. The MEMS 10 may have one or more of openings, cavities, channels, cantilevers, membranes and the like.

Exemplary MEMS 10 materials include, for example, silicon dioxide, silicon nitride, silicon, germanium, silicon carbide, quartz, GaAs, GaP, InP, polysilicon, air, glass, polymers, metals, silicon dioxide and high-k dielectric materials and the like and combinations thereof. It will be appreciated that other materials may also be included in MEMS 10. In one embodiment, MEMS 10 is fabricated from or on a silicon substrate using micromachining techniques.

Exemplary micromachining techniques to form the MEMS 10 include, for example, isotropic and anisotropic wet etching, dry etching, wafer bonding, surface micromachining, layer deposition, deep reactive ion etching (DRIE), micro-molding, lithography, and the like, and combinations thereof. It will be appreciated that other micromachining techniques may be used as known to those of skill in the art.

FIG. 2 illustrates a packaged MEMS 12 in accordance with one embodiment of the invention. The packaged MEMS 12 includes a MEMS 14 and a package 16. The MEMS 14 may be the same as or similar to MEMS 10. In FIG. 2, the MEMS 14 is shown entirely within the package 16. It will be appreciated that the particular arrangement of the MEMS 14 relative to the package 16 may vary from the illustrated embodiment.

The package 16 may include openings from the MEMS 10 to an external portion of the package 16, a structure to support and protect the MEMS 10, circuits coupled with the MEMS 10, signal lines coupled with the circuits, and the like. It will be appreciated that the package 16 may fully seal the MEMS 10 within the package 16.

The package may include one or more of, for example, silicon dioxide, silicon nitride, silicon, germanium, silicon carbide, quartz, GaAs, GaP, InP, polysilicon, air, glass, polymers, metals, and the like, and combinations thereof. It will be appreciated that the package may include other materials as known to those of skill in the art.

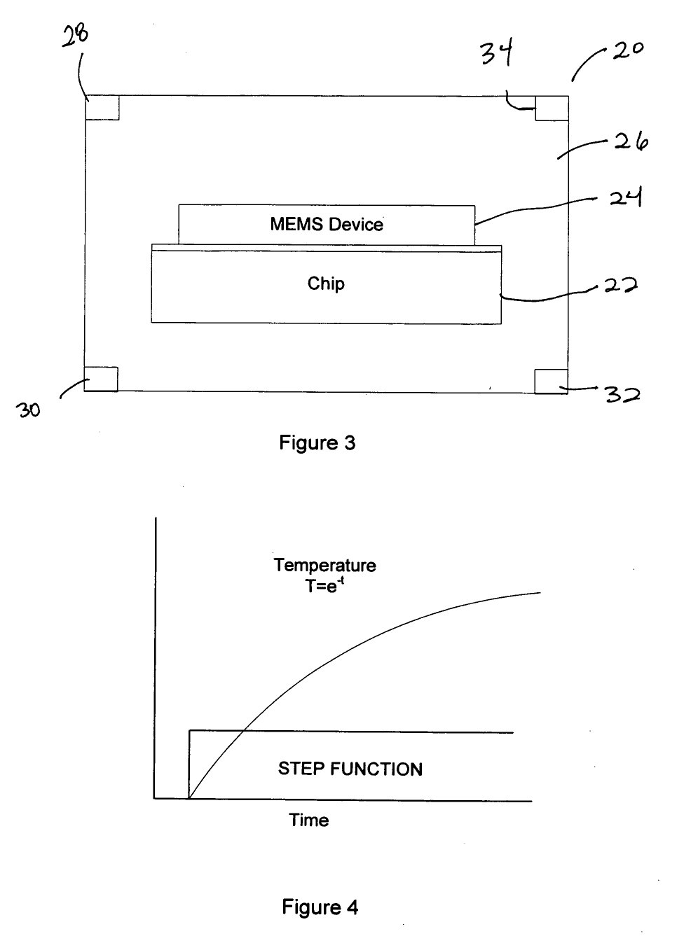

FIG. 3 illustrates an exemplary semiconductor device 20. The semiconductor device 20 includes a chip 22, a MEMS 24 and a package 26. In one embodiment, the MEMS 24 may be similar to or the same as MEMS 10, as described above with reference to FIG. 1. In another embodiment, the MEMS device 24 may be similar to or the same as packaged MEMS 12, as described above with reference to FIG. 2. It will be appreciated that MEMS device 24 is not limited to packaged MEMS 12 or MEMS 10 and may be any MEMS device.

The MEMS device 24 is shown on the chip 22. The chip 22 may include an integrated circuit. The chip 22 and MEMS device 24 may be electrically coupled with one another. It will be appreciated that the MEMs device 24 may also be integrated with the chip 22.

The package 26 may include openings from the MEMS device 24 to an external portion of the package 26, a structure to support and protect the MEMS device 24, circuits coupled with the MEMS device 24, signal lines coupled with the circuits, and the like. It will be appreciated that the package 26 may fully seal the MEMS device 24 within the package 26.

The package may be made from one or more materials including, for example, silicon dioxide, silicon nitride, silicon, germanium, silicon carbide, quartz, GaAs, GaP, InP, polysilicon, air, glass, polymers, metals, and the like, and combinations thereof. It will be appreciated that the package may include different materials as known to those of skill in the art.

The semiconductor device 20 also includes a control signal input 28, a ground 30, a control signal output 32 and a power input 34. The control signal input 28, ground 30, control signal output 32 and power input 34 are coupled with the MEMS 24 trough package 26 and chip 22.

In use, electrical energy is applied to the semiconductor device 20 by applying a voltage at power input 34 so that current flows through the MEMS device 24. When the current flows through the MEMS device 24, the MEMS device 24 heats up. Similarly, when electrical energy is applied to MEMS 10 as described above with reference to FIG. 1, or packaged MEMS 12 as described above with reference to FIG. 2, the MEMS 10 and packaged MEMS 12 heat up.

FIG. 4 graphically illustrates temperature and frequency as a function of time for an exemplary MEMS device (e.g., MEMS 10, packaged MEMS 12, MEMS device 24, etc.). In FIG. 4, the signal input (e.g., control signal and power) is constant, and, when power is applied, the temperature increases at a consistent rate until an equilibrium is reached. As the temperature of the MEMS device increases, energy in the form of heat escapes. The rate of temperature increase, as measured by the increase in frequency, reaches equilibrium when the heat input equals the heat output or the heat energy leakage equals the input electrical energy.

The relationship between electrical energy and heat can be determined as a function of time by measuring the frequency response (i.e., the difference between the control signal input 28 and the control signal output 32). This relationship between electrical energy and heat can be used to determine the temperature sensitivity of a MEMS device.

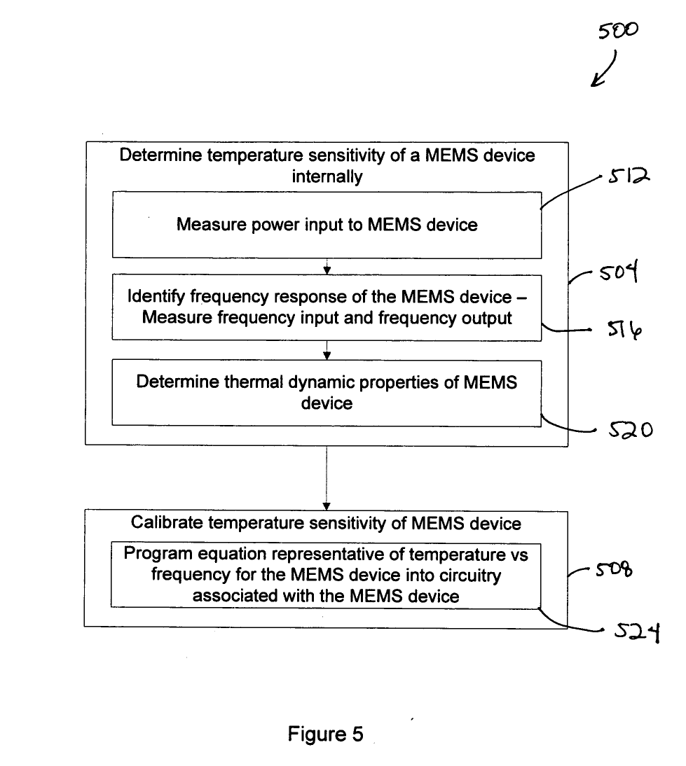

FIG. 5 illustrates an exemplary process of determining the temperature sensitivity of a MEMS device. The MEMS device may be MEMS 10, packaged MEMS 12 and/or semiconductor device 20. Once the temperature sensitivity of the MEMS device is known, the MEMS device can be calibrated according to the temperature sensitivity, as will be described in further detail hereinafter.

The process 500 begins by determining the temperature sensitivity of a MEMS device internally (block 504). The process 500 continues by calibrating the MEMS device (block 508).

Determining the temperature sensitivity of the MEMS device internally (block 504) includes measuring the power input to the MEMS device (block 512), identifying the frequency response of the MEMS device (block 516) and determining the thermal dynamic properties of the MEMS device (block. 520).

The thermal dynamic properties of the MEMS device or temperature sensitivity of the MEMS device can be determined by observing the offset of changing the quantity of heat energy contained in or at some exact mathematical point in a physical material. By observing the change in an electrical property of a physical material of the device, the temperature sensitivity of the MEMS device can be calculated.

The thermal dynamic properties and/or temperature sensitivity of the MEMS device can be used to calculate coefficients of a mathematical function of temperature as a function of frequency (or vice versa). The mathematical function is determined using well-known algorithms, such as, for example, a simplex algorithm. It will be appreciated that other algorithms can be used to determine the mathematical function. It will also be appreciated that the precision of the algorithm is dependent upon the amount of data available.

The power input to the MEMS device (block 512) includes measuring the voltage applied to the MEMS device and/or measuring the current of the MEMS device when a voltage is applied to the MEMS device (e.g., at power input 34). The frequency response of the MEMS device is identified (block 516) by measuring the frequency input and the frequency output of the MEMS device for a time period (e.g., at control signal input 28 and control signal output 32). The power input (block 512) and frequency response are measured continuously or at concurrent time intervals. In one embodiment, the power input (block 512) and frequency response (block 516) measurements only occur during ramp up. Ramp up is the time it takes to reach or approach the equilibrium point (i.e., the equilibrium point shown in FIG. 4). For an exemplary MEMS device, ramp up takes about eight seconds. In one embodiment, the time of measurements is any value or range of values less than about 8 seconds; however, it will be appreciated that the time range of measurements may be greater than or equal to about 8 seconds.

Once the relationship between temperature and frequency of the MEMS device is known, the MEMS device can be calibrated (block 508). The equation is determined using, for example, the simplex algorithm, and can be programmed into circuitry associated with the MEMS device (block 524).

In one embodiment, the MEMS device is calibrated to operate at a particular frequency. In another embodiment, the MEMS device is calibrated to measure temperature. It will be appreciated that the temperature sensitivity of the MEMS device can be used to calibrate the MEMS device for any number of purposes.

As discussed above, the temperature sensitivity of the MEMS device can be determined before the MEMS device is packaged, after the MEMS device is packaged, or after the MEMS device is on the chip. Similarly, the MEMS device can be calibrated before the MEMS device is packaged, after the MEMS device is packaged, or after the MEMS device is on the chip.

Typically, MEMS devices need to be calibrated to obtain a precise calibration curve. In one embodiment, the calibration curve is accurate within about 1 ppm over a range of temperature, such as about −40 F to 150 F.

It will be appreciated that the process of FIG. 5 allows a MEMS 10 to be calibrated at any temperature (i.e., without needing to vary the external temperature to identify the temperature sensitivity of the MEMS). For example, the process can occur at a room temperature.

In one embodiment, a representative MEMS device is used to calibrate similar MEMS devices made from the same materials. However, it will be appreciated that because the process 500 is fast, the temperature sensitivity of each MEMS device can be determined and each device can, optionally, be individually calibrated.

It will be appreciated that once the thermal dynamic properties of a representative MEMS device is known, an iterative algorithm can be used to determine the temperature sensitivity of each individual MEMS device. Thus, in one embodiment, the thermal properties of the MEMS device can be determined using a temperature chamber. The process of each individual MEMS device can then be determined using the known thermal properties of the representative device and the process 500 using an iterative algorithm.

One example of a MEMS resonator is a stable frequency source over a specified temperature range. Semiconductor devices are typically specified to function with some tolerance over the Industrial Temperature Range, which typically is about −40° C. to 85° C.

One exemplary use of the MEMS resonator is as a stable frequency source with a requirement that the frequency be within a limit of three sigma parts per million equal to 25 for any specified frequency over the Industrial Temperature Range. Another exemplary use of the MEMS resonator is as a temperature sensor with a three sigma error less than 0.1° C. over the Industrial Temperature Range.

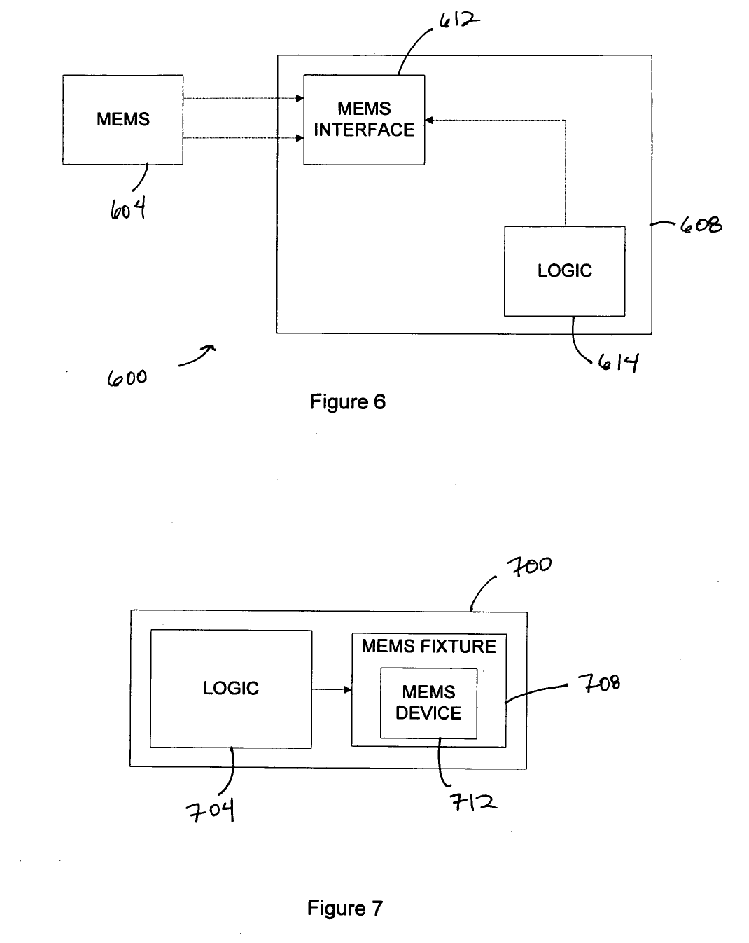

FIG. 6 illustrates an exemplary MEMS system in accordance with one embodiment of the invention. In the illustrated embodiment, the MEMS system 600 includes a MEMS device 604 and a chip 608. The chip 608 includes a MEMS interface 612 and logic 614. The MEMS device 604 is connected to the chip 608 via the MEMS interface 612. The logic 614 is coupled with the MEMS interface 612.

In one embodiment, the MEMS device 604 is a resonator and the chip 608 includes an integrated circuit that acts as a clock. In an embodiment in which the MEMS device 604 is a resonator, the temperature sensitivity of the MEMS device can be programmed into the logic 614 of the chip 608. With a clock, the MEMS system 600 is required to put out an approximately constant frequency for clocking purposes. The logic 614 can be programmed to compensate for changes in frequency associated with changes in temperature of the MEMS device 604 using the calibration data, as described above with reference to FIG. 5.

In another embodiment, the MEMS device 604 is a temperature sensor and the chip 608 includes an integrated circuit that allows the MEMS device 604 to measure temperature. The temperature sensitivity of the MEMS device can be programmed into the logic 614 of the chip 608, such that an external temperature of the MEMS device can be determined using the known thermal properties of the MEMS device.

FIG. 7 illustrates an exemplary testing system in accordance with one embodiment of the invention. The testing system 700 includes logic 704 and a MEMS fixture 708. The logic 704 is coupled with the MEMS fixture 708. A MEMS device 712 is insertable into the MEMS fixture 708. As described above, the MEMS device 712 can be tested before packaging, after packaging or on chip. It will be appreciated that if the MEMS device 712 is tested before packaging and, in some embodiments, after packaging and on chip, the logic 704 may be coupled with the MEMS device and programmed to apply the electrical energy to the MEMS device 712. In some embodiments after packaging and on chip, the logic 704 may be coupled with drive circuitry in the packaged MEMS or on chip MEMS devices.

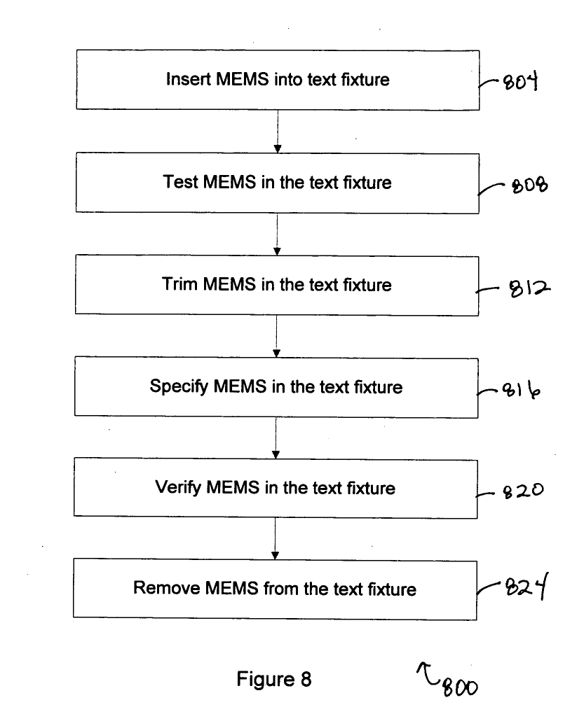

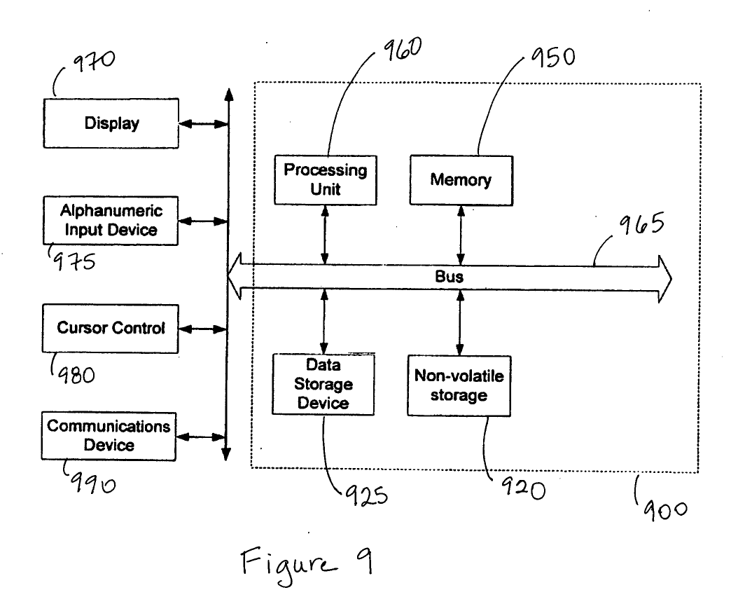

FIG. 8 illustrates a process for testing, trimming, specifying and verifying a MEMS resonator system in a single insertion in accordance with one embodiment of the invention. In one embodiment, the process of FIG. 8 is used with the testing system of FIG. 7. In one embodiment, the logic 704 is programmed to test, trim, specify and verify the MEMS resonator system.

The process 800 begins by inserting a MEMS into a test fixture (block 804). In one embodiment, the MEMS may be any of MEMS 10, packaged MEMS 12 or semiconductor device 20. It will be appreciated that other MEMS devices may be also be used with the process 800. In one embodiment, the test fixture is the test fixture 708 shown in FIG. 7.

The process 800 continues by testing the MEMS in the text fixture (block 808). Testing is well-known and, accordingly, is not described in further detail.

The process 800 continues by trimming the MEMS in the test fixture (block 812). Resonating MEMS devices are required to be trimmed or tuned to operate at a specific base frequency. The temperature sensitivity of the MEMS device is determined by, for example, using the process 500 described hereinabove. An offset is programmed into the logic associated with the MEMS device so that it operates at the specific base frequency. In one embodiment, the temperature sensitivity is determined and the offset is programmed in the test fixture.

The process 800 continues by specifying the MEMS in the text fixture (block 816). Specifying is well-known and, accordingly, is not described in further detail.

The process 800 continues by verifying the MEMS in the test fixture (block 820). Verifying is well-known and, accordingly, is not described in further detail.

The process 800 continues by removing the MEMS from the test fixture (block 824). It will be appreciated that the steps of the process may vary from that illustrated in FIG. 8 and that not all of the steps need to be performed.

### EXAMPLE

Table 1 below illustrates a MEMS resonator frequency as a function of time in 16 ms increments for 100 samples during start up. The frequency shown in the second column has a resolution of one cycle per second or one Hertz (Hz). The nominal resonator frequency is about 5 MHz. It will be appreciated that the minimum calibration data requirement is two temperature data points with two frequency data points. Two points define a straight line. Given a straight line, we can find the slope of the line and the interception of the line with the “x” axis, which we can assume is temperature Alternatively, the frequency can be obtained from the “y” axis at any point on the “x” temperature axis. For purposes of this example, we assume the physical relationship between temperature and frequency is, in fact, a straight line with is defined by a first order polynomial with the equation ax+b=0. If the functional relationship is defined by some other equation such as a second order polynomial, the procedure is essentially the same.

From the data in Table 1, we can compute the MEMS frequency different to be about 5.058939−5.058542, which is equal to 397 Hz. In order to find the frequency change as a function of temperature, which is the slope (parameter “b” in the above equation), we determine the difference between the beginning frequency and temperature and ending frequency and temperature. Since our mathematical model is a straight line the actual temperatures are not needed—only the temperature difference. If the start up temperature rise is known, we can determine the slope for the MEMS device of Table 1 by dividing 397 Hz by the temperature rise value in ° C. Likewise, if the slope (Hz/° C.) of the MEMS device of Table 1 is known, we can use this to determine the temperature rise in ° C. The nominal slope is 150 Hz/° C. Thus, the temperature rise is about 2.64666° C.

In order to determine the accuracy which can be achieved over the 125° C. Industrial Temperature Range, the ambient room temperature is considered, which is the temperature of the device at start up. Since 1° C. is about 150 Hz, the starting temperature should be determined with considerable accuracy. For example, an acceptable accuracy may be 0.1° C., corresponding to about 15 Hz or better. In the case of a stable frequency source requirement, a 25 ppm is 125 Hz; one ppm error is 5 Hz at 5 MHz. An error in the slope of plus or minus 1 Hz results in an error of plus or minus 60 Hz at 85° C. Assuming the slope is calculated from start up measurements at 25° C. and the start up temperature rise is 2° C., the error in frequency between the two frequency measurements is less than approximately 0.5 Hz.

The total MEMS frequency change in ppm is shown by PPM sum in the fourth column of Table 1. The third column shows the difference in frequency in ppm between each sample. As seen in Table 1, the frequency is decreasing as a function of time. The rate of decrease is also decreasing at a rate which is approximately exponential. By the last sample, the rate is roughly one half of a ppm per sample. Careful examination of the last samples shows the rate of decrease is not constant. For example, sample 88 is one ppm, with no change for samples 87 and 89. This is the result of the fact that the MEMS frequency is not free of a small noise signal of plus of minus about 1-2 Hz. The accuracy of the slope calculation can be improved by using curve fitting to get a more accurate estimate of the starting and ending “start up” frequency. Curve fitting reduces the effect of MEMS frequency noise.

TABLE 1

| Sample | Frequency | PPMdif | PPMsum |
|---|---|---|---|
| 0 | 5.058939 | 0 | 78.536 |
| 1 | 5.058901 | −7.65 | −7.65 |
| 2 | 5.058883 | −3.57 | −11.219 |
| 3 | 5.05887 | −2.55 | −13.769 |
| 4 | 5.058862 | −1.53 | −15.299 |
| 5 | 5.058849 | −2.55 | −17.849 |
| 6 | 5.058841 | −1.53 | −19.379 |
| 7 | 5.058834 | −1.53 | −20.909 |
| 8 | 5.058826 | −1.53 | −22.439 |
| 9 | 5.058821 | −1.02 | −23.459 |
| 10 | 5.058813 | −1.53 | −24.989 |
| 11 | 5.058805 | −1.53 | −26.519 |
| 12 | 5.058798 | −1.53 | −28.049 |
| 13 | 5.058792 | −1.02 | −29.069 |
| 14 | 5.058787 | −1.02 | −30.089 |
| 15 | 5.058779 | −1.53 | −31.619 |
| 16 | 5.058774 | −1.02 | −32.639 |
| 17 | 5.058769 | −1.02 | −33.658 |
| 18 | 5.058764 | −1.02 | −34.678 |
| 19 | 5.058759 | −1.02 | −35.698 |
| 20 | 5.058754 | −1.02 | −36.718 |
| 21 | 5.058751 | −0.51 | −37.228 |
| 22 | 5.058743 | −1.53 | −38.758 |
| 23 | 5.058741 | −0.51 | −39.268 |
| 24 | 5.058736 | −1.02 | −40.288 |
| 25 | 5.058733 | −0.51 | −40.798 |
| 26 | 5.058728 | −1.02 | −41.818 |
| 27 | 5.058725 | −0.51 | −42.328 |
| 28 | 5.058718 | −1.53 | −43.858 |
| 29 | 5.058715 | −0.51 | −44.368 |
| 30 | 5.058712 | −0.51 | −44.878 |
| 31 | 5.058707 | −1.02 | −45.898 |
| 32 | 5.058705 | −0.51 | −46.408 |
| 33 | 5.058699 | −1.02 | −47.428 |
| 34 | 5.058697 | −0.51 | −47.938 |
| 35 | 5.058694 | −0.51 | −48.448 |
| 36 | 5.058689 | −1.02 | −49.468 |
| 37 | 5.058687 | −0.51 | −49.978 |
| 38 | 5.058684 | −0.51 | −50.488 |
| 39 | 5.058679 | −1.02 | −51.508 |
| 40 | 5.058676 | −0.51 | −52.018 |
| 41 | 5.058674 | −0.51 | −52.528 |
| 42 | 5.058669 | −1.02 | −53.548 |
| 43 | 5.058666 | −0.51 | −54.058 |
| 44 | 5.058666 | 0 | −54.058 |
| 45 | 5.058661 | −1.02 | −55.078 |
| 46 | 5.058658 | −0.51 | −55.587 |
| 47 | 5.058656 | −0.51 | −56.097 |
| 48 | 5.05865 | −1.02 | −57.117 |
| 49 | 5.05865 | 0 | −57.117 |
| 50 | 5.058648 | −0.51 | −57.627 |
| 51 | 5.058643 | −1.02 | −58.647 |
| 52 | 5.058643 | 0 | −58.647 |
| 53 | 5.058638 | −1.02 | −59.667 |
| 54 | 5.058638 | 0 | −59.667 |
| 55 | 5.058632 | −1.02 | −60.687 |
| 56 | 5.058632 | 0 | −60.687 |
| 57 | 5.05863 | −0.51 | −61.197 |
| 58 | 5.058627 | −0.51 | −61.707 |
| 59 | 5.058625 | −0.51 | −62.217 |
| 60 | 5.05862 | −1.02 | −63.237 |
| 61 | 5.05862 | 0 | −63.237 |
| 62 | 5.058617 | −0.51 | −63.747 |
| 63 | 5.058614 | −0.51 | −64.257 |
| 64 | 5.058612 | −0.51 | −64.767 |
| 65 | 5.058609 | −0.51 | −65.277 |
| 66 | 5.058607 | −0.51 | −65.787 |
| 67 | 5.058604 | −0.51 | −66.297 |
| 68 | 5.058601 | −0.51 | −66.807 |
| 69 | 5.058599 | −0.51 | −67.317 |
| 70 | 5.058599 | 0 | −67.317 |
| 71 | 5.058596 | −0.51 | −67.827 |
| 72 | 5.058594 | −0.51 | −68.337 |
| 73 | 5.058591 | −0.51 | −68.847 |
| 74 | 5.058591 | 0 | −68.847 |
| 75 | 5.058589 | −0.51 | −69.357 |
| 76 | 5.058583 | −1.02 | −70.377 |
| 77 | 5.058586 | 0.51 | −69.867 |
| 78 | 5.058581 | −1.02 | −70.887 |
| 79 | 5.058581 | 0 | −70.887 |
| 80 | 5.058576 | −1.02 | −71.907 |
| 81 | 5.058573 | −0.51 | −72.417 |
| 82 | 5.058573 | 0 | −72.417 |
| 83 | 5.058571 | −0.51 | −72.927 |
| 84 | 5.058571 | 0 | −72.927 |
| 85 | 5.058568 | −0.51 | −73.437 |
| 86 | 5.058565 | −0.51 | −73.947 |
| 87 | 5.058565 | 0 | −73.947 |
| 88 | 5.05856 | −1.02 | −74.967 |
| 89 | 5.05856 | 0 | −74.967 |
| 90 | 5.058558 | −0.51 | −75.477 |
| 91 | 5.058558 | 0 | −75.477 |
| 92 | 5.058555 | −0.51 | −75.987 |
| 93 | 5.058552 | −0.51 | −76.497 |
| 94 | 5.058552 | 0 | −76.497 |
| 95 | 5.05855 | −0.51 | −77.007 |
| 96 | 5.05855 | 0 | −77.007 |
| 97 | 5.058547 | −0.51 | −77.516 |
| 98 | 5.058545 | −0.51 | −78.026 |
| 99 | 5.058542 | −0.51 | −78.536 |

Table 2 shows six trials of calculating the slope of the frequency for the MEMS device using five curve fitted start up frequency measurements of the kind shown in Table 1. In each case, the Plus 85 frequency is the room temperature frequency adjusted for the 60° C. difference between room temperature of 25° C. and 85° C. Careful review of the Good Slope average, 135.66 for the first set of five measurements, shows that slope values close to 135 have been used in the average. Bad data samples, such as 141.04 for the first and 601.86 in the fifth set of the five measurements, have been filtered out. When the six Good Slope values are averaged, the resulting value is 135.21. All of the Good Slopes are within about 0.5 Hz of the average. The Good Slope Three Sigma value is 18.99, which is determined by extrapolating the Good Slope calculation over the Industrial Temperature Range of −40° C. to 85° C.

In the case of the MEMS resonator used to produce a stable frequency source at a specified frequency, the MEMS resonator is used as an input to a phase lock loop (PLL) which is programmed to produce a frequency at some specified frequency. The temperature calibration data, which in this case is the frequency at a specified “zero temperature” and the slope of the frequency change versus temperature, is used by a temperature sensor inside the same packaged device to correct the MEMS frequency to 5.00 MHz. The PLL in turn uses the corrected MEMS frequency to produce a specified frequency of between about 1 to 125 MHz. One method of calibrating the start up temperature rise is to use the chip temperature sensor as a way to calibrate the MEMS frequency slope for a device which can in turn calibrate the device package temperature rise.

TABLE 2

| | Plus 85 | |
|---|---|---|
| | Frequency | Slope |
| Trial 1 | 5.050462 | 141.04 |
| | 5.050728 | 135.9 |
| | 5.050676 | 136.48 |
| | 5.050712 | 135.77 |
| | 5.050727 | 135.48 |
| | Good | 135.66 |
| | Slope | |
| Trial 2 | 5.050779 | 134.56 |
| | 5.050733 | 135.35 |
| | 5.050745 | 135.13 |
| | 5.050755 | 134.95 |
| | 5.050888 | 132.53 |
| | Good | 134.86 |
| | Slope | |
| Trial 3 | 5.050722 | 135.49 |
| | 5.050726 | 135.42 |
| | 5.050688 | 136.07 |
| | 5.05073 | 135.31 |
| | 5.050751 | 134.94 |
| | Good | 135.27 |
| | Slope | |
| Trial 4 | 5.050696 | 135.9 |
| | 5.050672 | 136.33 |
| | 5.050815 | 133.79 |
| | 5.050688 | 136.04 |
| | 5.050735 | 135.2 |
| | Good | 135.13 |
| | Slope | |
| Trial 5 | 5.050912 | 132.06 |
| | 5.050724 | 135.35 |
| | 5.050707 | 135.63 |
| | 5.020985 | 601.86 |
| | 5.05069 | 135.93 |
| | Good | 135.44 |
| | Slope | |
| Trial 6 | 5.050682 | 136.06 |
| | 5.050759 | 134.57 |
| | 5.05075 | 134.86 |
| | 5.050727 | 135.23 |
| | 5.050877 | 132.58 |
| | Good | 134.89 |
| | Slope | |

Table 3 shows the MEMS resonator frequency as a function of temperature where a temperature sensor in the same package as the MEMS resonator is used to measure the device temperature. The frequency of the phase lock loop (PLL) at a specified frequency of 100 MHz is shown in the fifth column. The slope of 135.35 Hz/° C. has been used to convert the MEMS frequency to a temperature. Sample 17 shows that the MEMS temperature and the chip temperature are almost exactly at 30° C. By suitable adjustments to the slope and the start up temperature, the MEMS temperature and chip temperature can be made to match, resulting in a device having a calibrated MEMS resonator.

TABLE 3

| Sample | Mems- | | | |
|---|---|---|---|---|
| # | Temp | MemsFreq | ChipTemp | PLLFreq |
| 5 | 1.386 | 5.058567 | 5.09 | 99.9982 |
| 6 | 1.725 | 5.058522 | 5.98 | 99.9989 |
| 7 | 1.854 | 5.058504 | 5.98 | 99.9989 |
| 14 | 28.18 | 5.054967 | 28.62 | 99.9988 |
| 15 | 28.833 | 5.05488 | 29.51 | 99.9991 |
| 16 | 29.409 | 5.054802 | 29.51 | 99.9985 |
| 17 | 30 | 5.054723 | 29.95 | 99.9983 |
| 18 | 39.55 | 5.05344 | 38.39 | 99.999 |
| 19 | 40.435 | 5.053321 | 39.28 | 99.9993 |
| 20 | 41.14 | 5.053226 | 39.72 | 99.999 |
| 21 | 41.782 | 5.05314 | 40.16 | 99.9988 |
| 41 | 60.324 | 5.050649 | 55.7 | 99.9991 |
| 42 | 61.018 | 5.050556 | 56.14 | 99.9989 |
| 43 | 61.703 | 5.050464 | 56.59 | 99.9985 |
| 44 | 62.363 | 5.050375 | 57.48 | 99.9991 |
| 45 | 59.264 | 5.050791 | 54.81 | 99.999 |
| 46 | 59.525 | 5.050756 | 54.81 | 99.9985 |
| 47 | 59.635 | 5.050742 | 55.26 | 99.9991 |
| 48 | 59.654 | 5.050739 | 55.26 | 99.9989 |
| 49 | 59.663 | 5.050738 | 55.26 | 99.9988 |
| 50 | 59.611 | 5.050745 | 55.26 | 99.999 |
| 51 | 59.454 | 5.050766 | 54.81 | 99.9986 |
| 52 | 59.378 | 5.050776 | 54.81 | 99.9987 |
| 53 | 59.316 | 5.050784 | 54.81 | 99.9987 |
| 54 | 59.183 | 5.050802 | 54.81 | 99.999 |
| 55 | 59.121 | 5.050811 | 54.81 | 99.999 |
| 56 | 59.016 | 5.050825 | 54.81 | 99.999 |
| 107 | −49.222 | 5.065366 | −298.15 | 101.3099 |
| 108 | −48.911 | 5.065325 | −298.15 | 100.1651 |
| 109 | −48.404 | 5.065257 | −298.15 | 100.1519 |
| 121 | −28.895 | 5.062635 | −22.43 | 99.9984 |
| 122 | −25.656 | 5.0622 | −19.32 | 99.9987 |
| 123 | −22.857 | 5.061824 | −16.66 | 99.9985 |
| 124 | −20.47 | 5.061504 | −14.44 | 99.9986 |
| 125 | −18.527 | 5.061243 | −12.66 | 99.9986 |
| 126 | −16.832 | 5.061015 | −10.89 | 99.9988 |
| 127 | −15.361 | 5.060817 | −10 | 99.9983 |
| 140 | −5.373 | 5.059475 | −0.68 | 99.9986 |
| 141 | −4.958 | 5.05942 | −0.23 | 99.9987 |
| 142 | −4.562 | 5.059366 | −0.23 | 99.9982 |
| 143 | −4.204 | 5.059318 | 0.65 | 99.9991 |
| 144 | −3.808 | 5.059265 | 0.65 | 99.9985 |
| 145 | −3.45 | 5.059217 | 1.1 | 99.9986 |
| 146 | −3.15 | 5.059177 | 1.54 | 99.999 |
| 147 | −2.864 | 5.059138 | 1.54 | 99.9987 |
| 148 | −2.592 | 5.059102 | 1.54 | 99.9982 |
| 149 | −2.329 | 5.059066 | 1.99 | 99.9988 |
| 150 | −1.972 | 5.059018 | 2.43 | 99.9986 |

TABLE 4

| Plus 85 | |
|---|---|
| Frequency | Slope |
| 5.057442 | 12.01 |
| 5.050897 | 130.04 |
| 5.050707 | 133.89 |
| 5.050661 | 134.81 |
| 5.050634 | 135.32 |
| Good | 134.35 |
| Slope | |

Using the calibrated MEMS resonator, the start up temperature rise can be determined.

The three sigma 25 ppm frequency calibration of the Industrial Temperature Range requires the frequency accuracy to be about 125 cycles or better. The three sigma 0.1 ppm temperature calibration over the Industrial Temperature Range requires the frequency accuracy to be about 15 cycles or better. Thus, in order to satisfy this requirement, the accuracy should be increased by at least an order of magnitude.

In the room temperature calibration procedure using a socket at ambient (i.e., room) temperature, the self-heating temperature rise is the difference between the MEMS resonator frequency and the socket temperature at the end of startup. This occurs when the internally generated heat energy (watts) equals the heat energy in the form of conduction, convection and radiation escaping the device package. One source of frequency measurement errors is the fact that this heat leakage from the device package varies from insertion to insertion for the same device. This source of error as well as others can be eliminated using a heated socket.

A heated test socket is an extension of the room temperature calibration procedure described above, which can be used to increase the temperature accuracy considerably. Using a device such as a peltier heat pump to pump heat into or out of a heat sink attached to the socket, the socket temperature can be adjusted to temperatures in the range of about 50° C. above or below ambient temperature.

In one embodiment, when the device at room temperature is placed in the socket, also at room temperature, the socket temperature is ramped down to a value less than the self heating temperature rise which is about 3° C. As soon as frequency measurements detect that the temperature of the MEMS resonator is decreasing, the direction of the socket temperature ramp is reversed. Heat energy which was flowing out of the package as shown by decreasing MEMS frequency begins to flow in the opposite direction. The MEMS resonator frequency will reverse direction when the internal device temperature reaches an inflection point where the heat energy entering (self-heating) the package and the heat energy escaping from the package are equal. At this point, the frequency of a calibrated device in an identical socket attached to the same heat sink can be measured. Thus, two frequency measurements from two devices which are known to be at the same temperature can be resolved. The value of the temperature can be determined with an accuracy of the frequency measurement accuracy and the accuracy of the calibration of the calibrated reference device.

The resulting frequency accuracy measurements can be 0.1 Hz. The accuracy of the temperature calibration of the reference MEMS resonator can be 0.5° C. or better. Thus, a frequency/temperature data point for the MEMS device to be calibrated is known. Using the heat pump, the socket and device are heated until temperature of up to about 50° C. above ambient temperature is reached. At this point, the direction of the heat pump can be again reversed. A second frequency inflection point can be used to obtain a second frequency temperature data point.

Using the above procedure, two highly precise points on a straight line which are far apart in temperature as necessary to achieve a reasonable calibration accuracy are determined. Thus, heated test sockets can increase accuracy by at least a factor of ten.

It will be appreciated that a MEMS temperature sensor can also be used with the heated or unheated room temperature calibration method.

It will be appreciated that although some of the systems and methods have been described with reference to MEMS resonators, it will be appreciated that the systems and methods described herein are applicable to other MEMS devices. For example, the MEMS device may be a temperature sensor, pressure sensor, accelerometer, and the like.

FIG. 9 is one embodiment of a computer system on which embodiments of the present invention may be implemented. It will be apparent to those of ordinary skill in the art, however, that other alternative systems of various system architectures may also be used.

The data processing system illustrated in FIG. 9 includes a bus or other internal communication means 965 for communicating information, and a processor 960 coupled to the bus 965 for processing information. The system further comprises a random access memory (RAM) or other volatile storage device 950 (referred to as memory), coupled to bus 965 for storing information and instructions to be executed by processor 960. Main memory 950 also may be used for storing temporary variables or other intermediate information during execution of instructions by processor 960. The system also comprises a read only memory (ROM) and/or static storage device 920 coupled to bus 965 for storing static information and instructions for processor 960, and a data storage device 925 such as a magnetic disk or optical disk and its corresponding disk drive. Data storage device 925 is coupled to bus 965 for storing information and instructions.

The system may further be coupled to a display device 970, such as a cathode ray tube (CRT) or a liquid crystal display (LCD) coupled to bus 965 through bus 965 for displaying information to a computer user. An alphanumeric input device 975, including alphanumeric and other keys, may also be coupled to bus 965 through bus 965 for communicating information and command selections to processor 960. An additional user input device is cursor control device 980, such as a mouse, a trackball, stylus, or cursor direction keys coupled to bus 965 through bus 965 for communicating direction information and command selections to processor 960, and for controlling cursor movement on display device 970.

Another device, which may optionally be coupled to computer system 900, is a communication device 990 for accessing other nodes of a distributed system via a network. The communication device 990 may include any of a number of commercially available networking peripheral devices such as those used for coupling to an Ethernet, token ring, Internet, or wide area network. The communication device 990 may further be a null-modem connection, or any other mechanism that provides connectivity between the computer system 900 and the outside world. Note that any or all of the components of this system illustrated in FIG. 9 and associated hardware may be used in various embodiments of the present invention.

It will be appreciated by those of ordinary skill in the art that any configuration of the system may be used for various purposes according to the particular implementation. The control logic or software implementing the present invention can be stored in main memory 950, mass storage device 925, or other storage medium locally or remotely accessible to processor 960.

It will be apparent to those of ordinary skill in the art that the system, method, and process described herein can be implemented as software stored in main memory 950 or read only memory 920 and executed by processor 960. This control logic or software may also be resident on an article of manufacture comprising a computer readable medium having computer readable program code embodied therein and being readable by the mass storage device 925 and for causing the processor 960 to operate in accordance with the methods and teachings herein.

The present invention may also be embodied in a handheld or portable device containing a subset of the computer hardware components described above. For example, the handheld device may be configured to contain only the bus 965, the processor 960, and memory 950 and/or 925. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above. For example, the appliance may include a processor 960, a data storage device 925, a bus 965, and memory 950, and only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism.

It will be appreciated by those of ordinary skill in the art that any configuration of the system may be used for various purposes according to the particular implementation. The control logic or software implementing the present invention can be stored on any machine-readable medium locally or remotely accessible to processor 960. A machine-readable medium includes any mechanism for storing or transmitting information in a form readable by a machine (e.g. a computer). For example, a machine readable medium includes read-only memory (ROM), random access memory (RAM), magnetic disk storage media, optical storage media, flash memory devices, electrical, optical, acoustical or other forms of propagated signals (e.g. carrier waves, infrared signals, digital signals, etc.).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. A method comprising:
determining a temperature response of a MEMS device at an arbitrary temperature; and
calibrating the MEMS device based on the temperature response.

2. The method of claim 1, wherein determining the temperature response of the MEMS device comprises determining a power input, frequency input and frequency output of the MEMS device.

3. The method of claim 1, wherein determining the temperature response comprises determining a transient frequency response of the MEMS device based on the frequency input and the frequency output of the MEMS device.

4. The method of claim 1, wherein the arbitrary temperature is room temperature.

5. The method of claim 1, wherein determining the temperature response comprises heating the MEMS device.

6. A method comprising:
determining a frequency response of a MEMS device;
determining polynomials of a quadratic equation representative of the frequency response of the MEMS device as a function of temperature; and
calibrating the MEMS device using the quadratic equation.

7. The method of claim 6, wherein determining a frequency response comprises determining a power input, a frequency input and a frequency output of the MEMS device.

8. The method of claim 6, wherein determining a frequency response of the MEMS device comprises determining a transient frequency response of the MEMS device.

9. A method comprising:
measuring a transient frequency response and power of a MEMS device;
calibrating a temperature sensitivity of the MEMS device using the transient frequency response.

10. The method of claim 9, wherein measuring the transient frequency response of the MEMS device comprises measuring a frequency input and a frequency output during a predetermined amount of time.

11. The method of claim 10, wherein the predetermined amount of time is less than about eight seconds.

12. The method of claim 10, wherein the predetermined amount of time is less than about two seconds.

13. The method of claim 9, wherein measuring the transient frequency response of the MEMS device comprises heating the MEMS device.

14. A method comprising:
testing a MEMS device in a test fixture;
trimming the MEMS device in the test fixture;
specifying the MEMS device in the test fixture; and
verifying the MEMS device in the test fixture.

15. The method of claim 14, wherein trimming the MEMS device in the test fixture comprises:
determining a frequency response of the MEMS device;
determining polynomials of a quadratic equation representative of the frequency response of the MEMS device as a function of temperature; and
calibrating the MEMS device using the quadratic equation.

16. The method of claim 14, wherein trimming the MEMS device in the test fixture comprises:
measuring a transient frequency response and power of the MEMS device;
calibrating a temperature sensitivity of the MEMS device using the transient frequency response.

17. The method of claim 14, wherein trimming the MEMS device in the test fixture comprises heating the MEMS device.

18. A system comprising:
a text fixture to receive a MEMS device;
a power input coupled to the test fixture;
a frequency input coupled to the test fixture;
a frequency output coupled to the test fixture; and
a processor to measure the power input, frequency input and frequency output and determine a temperature sensitivity of the MEMS device based on the power input, frequency input and frequency output.

19. The system of claim 18, wherein the processor is to measure the power input, frequency input and frequency output at an arbitrary temperature.

20. The system of claim 18, wherein the text fixture is heatable.

21. The system of claim 18, wherein the text fixture is configured to heat the MEMS device.
